(19) United States
(12) Patent Application Publication
(10) Pub. No.: US 2019/0023596 A1
(43) Pub. Date: Jan. 24, 2019

(54) Negative Pressure Aeration And Organic Growth Suppression System

(71) Applicant: Richard Steven Trela, Tampa, FL (US)

(72) Inventor: Richard Steven Trela, Tampa, FL (US)

(21) Appl. No.: 16/043,723

(22) Filed: Jul. 24, 2018

Related U.S. Application Data
(60) Provisional application No. 62/536,001, filed on Jul. 24, 2017.

(51) Int. Cl. C02F 9/00; B01D 29/31; B01D 39/16; B01D 39/20; B63J 4/00; B63J 2/00

(52) U.S. Cl. CPC C02F 9/00; B01D 29/31; B01D 39/16; C02F 2103/08; B63J 4/00; B63J 2/00; B01D 39/2027

(57) ABSTRACT

A negative pressure aeration system, created by atmospheric siphon pressure above the waterline and mechanical pump suction below the waterline, which impedes the growth of organic matter. A waterfall in vacuum effect is created within a processing unit that aerates the raw water as it falls through the air chamber of the processing unit housing, which assists in the suppression of organic growth by reducing the contact surface area within the processing unit. A chemical tank allows an anti-fouling chemical to be added to the entire system and a power supply allows flexible electrodes driven by a vacuum to create a further anti-fouling benefit throughout the components of the system.

### CROSS-REFERENCE TO RELATED APPLICATIONS

This application claims priority to pending provisional application No. 62/536,001, filed Jul. 24, 2017, the disclosure of which is hereby incorporated by reference herein.

### BACKGROUND OF THE INVENTION

### Field of the Invention

This invention relates to a negative pressure aeration and organic growth suppression system. Specifically, an apparatus that collects solid marine debris at the inlet of a raw water cooling system and through negative pressure aeration, suppresses the growth and accumulation of the debris.

### Description of the Background Art

Presently, marine raw water cooling systems are used to circulate cooling water throughout the heat generating components of a marine cooling system. The system begins when raw water enters the hull of the boat, via a pump, through a seacock or ball valve, located below the boat's water line. From there, the raw water travels through a hose to an inlet of a raw water strainer. The strainer includes a cylindrical object or collector basket wherein the debris is collected, thus preventing debris travel through the rest of the cooling system. Then, the raw water exits the outlet side of the strainer and travels through a hose to the pump, which transfers the water throughout the rest of the cooling system. The rest of the cooling system includes a series of pipes and hoses connected to a heat exchanger, such as air conditioning condenser coils where the heat exchange process occurs. After the raw water undergoes the heat exchange, the hot water is pumped/transferred back into the lake, ocean, etc. via the outlet port.

This method of processing has been used for many decades, yet it is highly prone to the accumulation of debris and organic matter. The strainer is typically insufficient in preventing the debris and organic matter from flowing throughout the rest of the pumping system. Consequently, the unwanted accumulation of debris and organic matter then interferes with the heat exchange process. That is, the debris and organic matter clog the pipes and hoses and results in reduced heat exchange.

The maintenance on such processes is considerable and requires knowledge of the system. Furthermore, cleaning the entire system not only removes mobile debris, but also removes organic matter that has been stagnant for a period of time. As such, barnacles often begin to grow when the boat is not in consistent operation and/or when the marine cooling system has not been properly cleaned for a period of time. Thus, an expensive system clean includes a chemical flush and a series of scrubbing techniques and is the standard method to restore the system to an operational cooling level.

The current technology of the strainer utilizes a closed, water-tight, air-free strainer, which is typically located below the boat's water line. As such, if the strainer becomes structurally unsound, via a leak, the hull of the boat may fill with water and sink.

Therefore, it is an object of this invention to provide an improvement, which overcomes the aforementioned inadequacies of the prior art devices and provides an improvement, which is a significant contribution to the advancement of negative pressure aeration and organic growth suppression systems.

Another object of this invention is to provide a processing unit that suppresses the accumulation and growth or organic matter and marine debris by way of having an inlet port positioned within a strainer and above an outlet port, which is not positioned within the strainer.

Another object of this invention is to provide an anti-fouling, gravity-fed chemical tank that can be operatively connected to the processing unit to aid in the addition and distribution of anti-fouling chemicals to the entire system.

Another object of this invention is to provide an electrode assembly within the processing unit and/or inlet hose to further prevent the accumulation and growth of organic matter and marine debris.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a negative pressure aeration and organic growth suppression system.

Embodiments of the present invention are herein described by way of example and directed to a negative pressure aeration and organic growth suppression system. The aforementioned state of the art of negative pressure aeration and organic growth suppression system shows the need for improvements, specifically in the area of preventing marine debris and organic matter from accumulating and growing within the system.

The negative pressure aeration and organic growth suppression system of the present invention satisfies the aforementioned deficiencies because it provides an efficient and effective raw water strainer and processing unit that collects solid marine debris, such as sea grass, and aerates the raw water before it enters the strainer component of the housing so as to shorten the residence time of the debris in the processing unit. Aerating the raw water suppresses its growth by reducing its residence time in the housing unit, which reduces the growth and accumulation in the rest of the air conditioning system, such as in the up-line components of the system, condenser coils, etc.

The present invention also maximizes the pump's efficiency due to a pressure siphon effect by way of above waterline installation. That is, the processing unit of the present invention is installed above the boat's waterline, or above the bilge. Thus, it will likely be located higher than the pump that leads/pumps to the air conditioning unit. As such, the processing unit is able to create a vertical height differential, thus allowing an atmospheric siphon pressure gradient to form, which allows the filtered water to be effectively “pushed” into the pump, by way of being vertically higher than the pump. Since the filtered water is pushed into the pump, the pump necessarily uses less energy to provide sufficient fluid flow into the rest of the air conditioning system.

The processing unit is configured to allow the raw unstrained sea water to effectively fall from the inlet port to the outlet port, through the strainer. This is called the “waterfall effect” and allows the raw water to be aerated in the strainer process, between the inlet and outlet ports. The waterfall effect reduces the residence time of the water, thus suppressing accumulation and growth of debris and organic matter during the straining process. The strainer is configured to have many sieve holes to catch/strain both large and small debris.

The processing unit includes an access port that allows a user to access accumulated debris within the strainer. The port is airtight and large enough for the user to grasp the accumulated debris. The user is able to access accumulations of debris, such as sea shells and grass, from the processing unit that has been separated as part of the gravity fed, aerated strainer process.

The processing unit includes a water priming access port that allows a “hot operation” water pump priming source to be added at any point during the operation of the air conditioning unit. This new method is in contrast to current methods whereby priming water can only be added by either opening a fully sealed system at a hose fitting or back-feeding from a dock through the outlet port of the air conditioning system.

As stated before, since the current technology places the strainer assembly below the boat's waterline, in the bilge, it must be structurally sound because any slight leak within the strainer assembly may cause large amounts of water to rush into the bilge of the boat, possibly resulting in sinking. Typically, however, a heavy-duty bilge pump may be able to offset the amount of water entering the bilge via the damaged strainer.

Here, the strainer assembly is housed within the processing unit, which is placed above the boat's waterline. As such, the raw water inlet hose is attached to the processing unit's inlet port, located above the boat's waterline. This is a vital safety issue as the risk in housing failure is limited to the siphon effect being interrupted due to the vacuum loss in the housing. In this case, the raw inlet water would just remain in the inlet hose at the external waterline level and not flood the bilge of the boat.

The water priming access port also enables a user to add liquids to the system, which will then be circulated throughout the entire air condition system. The liquids may include chemicals such as Barnacle Buster® or other system flushing additives.

The present invention also includes the use of an anti-fouling electrode assembly whereby the raw sea water is electrified via a direct current (“DC”) power supply, thus helping prevent the accumulation and growth of subaquatic organisms. The electrode assembly are present throughout the inlet hose and the processing unit. The DC power supply is 12-24 volts, which can be automatically turned on via an inline vacuum switch that operates so as to turn on the DC power supply when a vacuum is present during the operation of the pump and vice versa.

The processing unit can be disposable. To accomplish this purpose, the processing unit does not need an access port and the user does not need to clean the strainer of any accumulated debris. The processing unit would be able to be manufactured with economic materials, such as aluminum or polyvinyl chloride. The user would wait until the prescribed period and then dispose of the processing unit.

The processing unit can further be used for cooling other systems in a vessel employing other types of heat exchanges, such as engine blocks and generator engines.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a schematic view of the negative pressure aeration and organic growth suppression system in accordance with the underlying principles of the present invention;

FIG. 2 is a top plan view of the processing unit.

FIG. 3 is a cross sectional view of the processing unit.

FIG. 4 is a schematic view of the system with the pump switched to an operational position and the chemical tank switched to a non-operational position.

FIG. 5 is a schematic view of the system with the pump switched to a non-operational position and the chemical tank switched to an operational position.

FIG. 6 is a schematic view of the system with the pump switched to a non-operational position for a period of time longer than the chemical tank switched to a non-operational position.

FIG. 7 is a non-operational schematic view of the system with the inclusion of the DC power supply, corresponding electrodes and vacuum switch.

FIG. 8 is a operational schematic view of the system with the inclusion of the DC power supply, corresponding electrodes and vacuum switch.

Similar reference characters refer to similar parts throughout the several views of the drawings.

### DETAILED DESCRIPTION OF THE PREFERRED EMBODIMENT

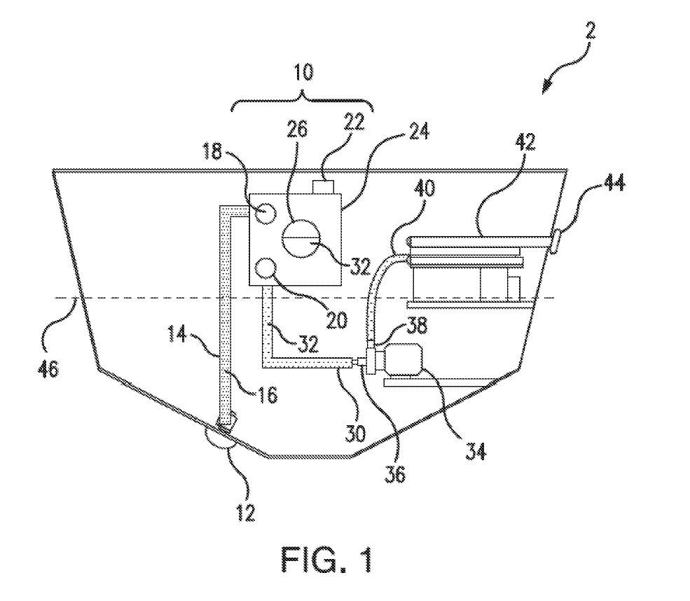

As shown in FIG. 1, a processing unit 10 includes an inlet port 18 and an outlet port 20. The inlet port 18 receives the proximal end of an inlet hose 14, which has its volume either composed of an unstrained fluid 16, a chemical agent 60 or a chemical mixture 62. The connection between the inlet port 18 and the inlet hose 14 may be of any traditional method such as a threaded hose connector. Once a pump 34 is turned on, the inlet hose 14 receives the unstrained fluid 16 via the seacock 12, which is an interface between a body of water and a hull of a boat, thus allowing sea water, lake water, etc. to enter the inlet hose 14. The connection between the seacock 12 and the distal end of the inlet hose 14 may be of any traditional method such as a threaded hose connector. The seacock 12 must be located below the boat's waterline 46 to be able to have atmospheric pressure drive the unstrained fluid 16 into the inlet hose 14.

The unstrained fluid 16 travels towards the processing unit 10 and enters the processing unit 10 via the inlet port 18. The unstrained fluid 16 undergoes filtration/straining via the strainer 26 located within the processing unit 10, thus becoming a strained fluid 32. The processing unit 10 includes the strainer lid 48.

The strained fluid 32 exits the processing unit 10 via the the outlet port 20, which is connected to the proximal end of an outlet hose 30. The strained fluid 32 then travels towards the distal end of the outlet hose 30, which is connected to a pump 34 via a pump inlet port 36. The pump 34 then transfers the strained fluid 32 to an air conditioning inlet hose 40 via the pump outlet port 38. The strained fluid 32 then travels to the air conditioning system 42, whereupon the heat exchange process occurs. The air conditioning system 42 is of a typical type used in the marine industry that requires a cooling liquid to be distributed throughout the system for a proper heat exchange process to occur. Once the strained fluid 32 travels through the air conditioning system 42, it exits the system 2 via the air conditioning outlet port 44.

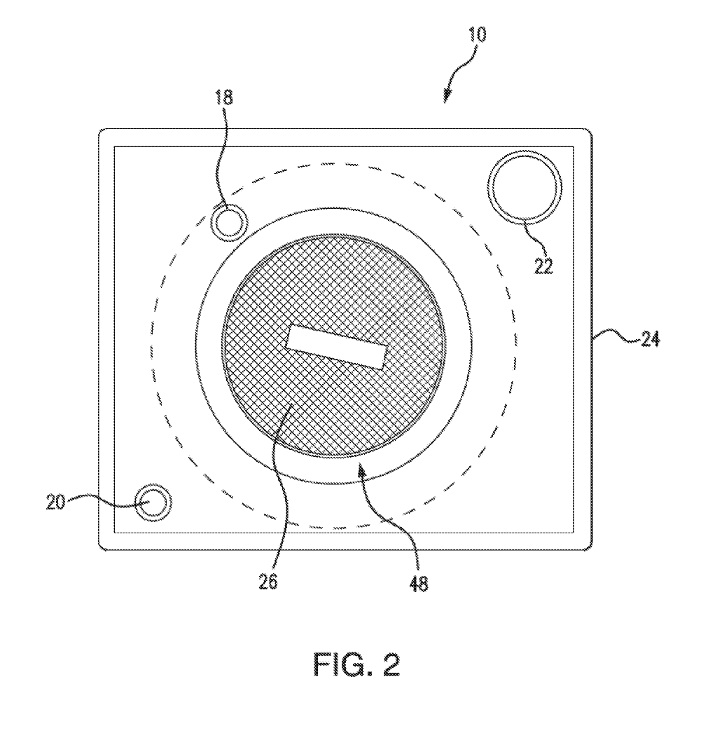

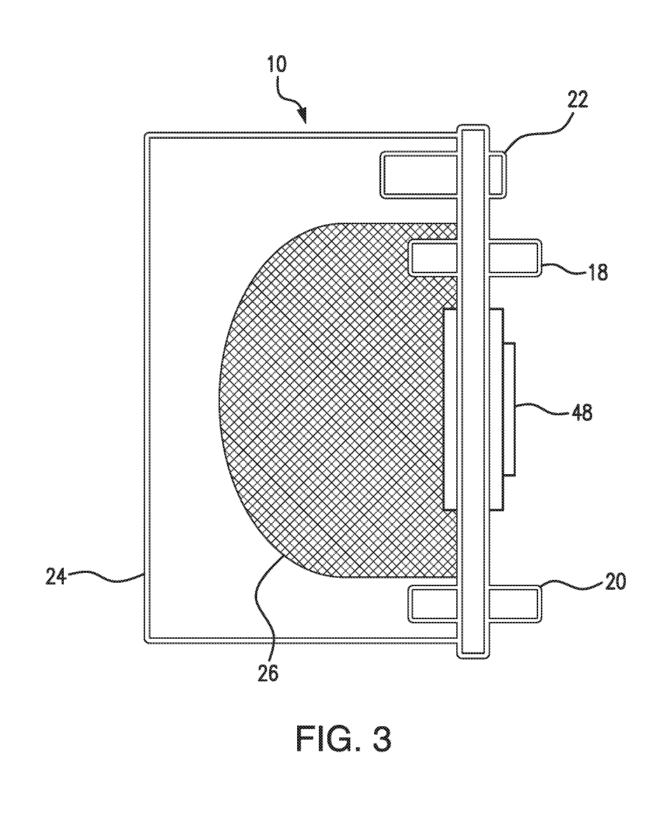

As shown in FIGS. 2 and 3, the strainer 26 is located within the processing unit housing 24. The strainer is preferably a single strainer, dome-shaped and composed of stainless steel or a heavy-duty plastic material. Further, the strainer 26 has a multitude of sieve holes, preferably in the hundreds. The sieve holes are designed to be small enough to catch debris before exiting the outlet port 20 and into the outlet hose 30.

The strainer may be configured to have varying geometries such as an irregular cylinder-like object, perfect cylinder, cone-shaped cylinder, reverse cone-shaped cylinder and/or any object with multiple sides that can be linear or nonlinear. For instance, the strainer may have an upper body with the geometry of a square and a lower body with the geometry of a cylinder, which may be removed all at once or piece-wise. Furthermore, multiple layers of strainers within a single strainer is contemplated and may be used for the purpose of sifting larger through smaller objects. The varying layers of the strainer may then be removed all at once or piece-wise. The processing unit may further include multiple strainers. The strainers may also be coated with anti-fouling liquids for the purposes of decreasing the growth of organic matter and/or rust. For example, having a disposable strainer composed of inexpensive material, such as plastic, coated with Barnacle Buster® and other chemicals for the purposes of slowly leaching the chemicals into the system's fluids while in operation. The strainer may also have disposable coatings attached to itself. That is, a disposable strainer-shaped material is added to the strainer for the purposes of acting as a further sieve or chemical leaching component. Once the user has flushed the system, the user may remove the disposable material.

The processing unit housing 24 preferably has a clear strainer lid 48 to allow the user an unimpeded view of the strainer 26. The user may remove the lid 48 to remove any accumulated debris or organic matter.

As shown in FIG. 3, the processing unit 10 includes an access port 22 that allows a user to add priming water to the system 2. For instance, if the system needs to be primed, to perfect both a water and air tight seal, the user may add additional water to the system 2 by opening the access port 22. The access port 22 further includes the ability to allow a user to add anti-fouling liquids and other chemicals to the system 2, for the purposes of cleaning and/or flushing the system 2. The access port 22 is preferably composed of a traditional cap and screw configuration. Furthermore, the access port 22 is located within the processing unit housing 24; however, not within the volume encompassed by the strainer 26.

Notably, in FIG. 3, the inlet port 18 is within the volume encompassed by the strainer 26, while the outlet port 20 is not within the volume encompassed by the strainer 26. The unstrained fluid 16 exits the inlet hose 14 via the inlet port 18 and into the strainer 26, whereby the unstrained fluid 16 passes through the sieve holes of the strainer 26 and exits the processing unit 10 via the outlet port 20. The force generated by the pump 34 allows a waterfall effect to occur within the processing unit 10. When the unstrained fluid 16 enters the processing unit 10 through the inlet port 18, the unstrained fluid 16 then falls, via gravity, through the strainer 26 and out of the processing unit 10 via the outlet port 20. The waterfall effect provides an aeration method for the unstrained fluid 16. That is, the waterfall effect creates a mixture of unstrained fluid 16 and air in between the inlet port 18 and the outlet port 20. The mixture of unstrained fluid 16 and air allows less surface area of the processing unit 10 to be covered by unstrained fluid 16, thus providing for less time for organic matter to accumulate on the surfaces of the processing unit 10.

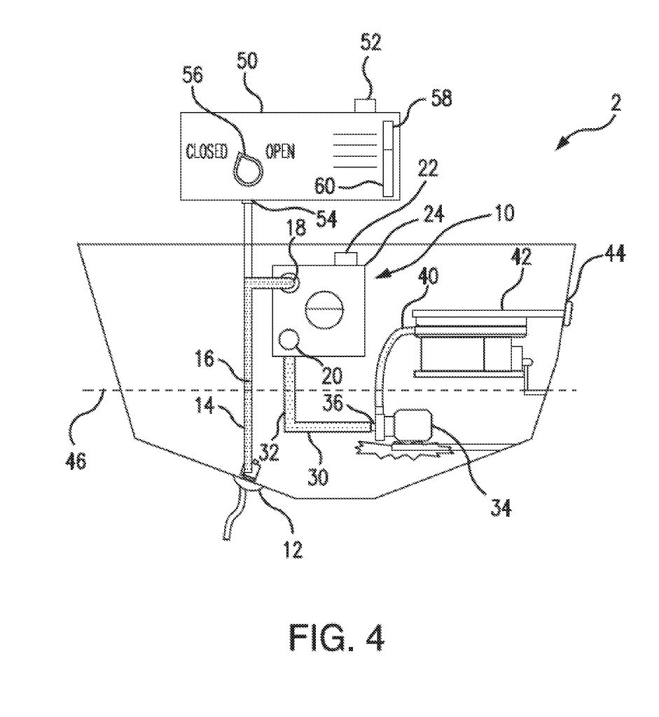

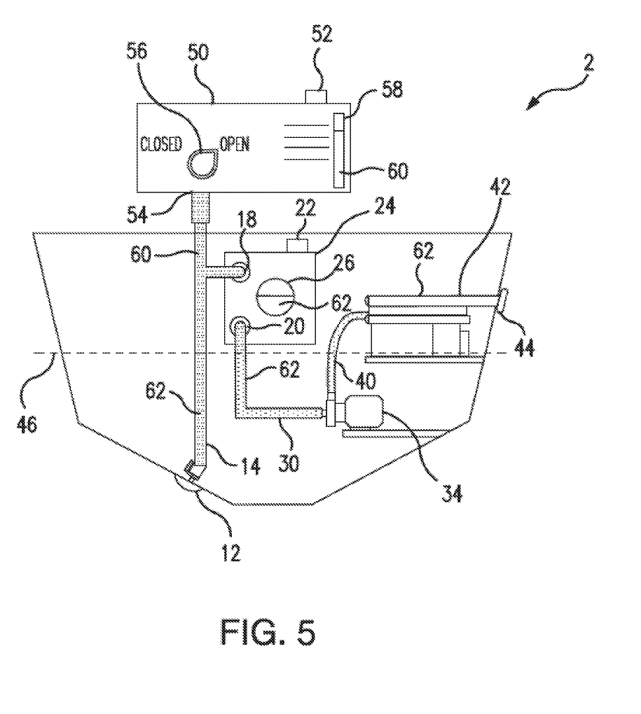

As shown in FIGS. 4 and 5, a chemical tank 50 may be added to the system 2 for anti-fouling purposes. The chemical tank 50 is connected to the inlet hose 14 at any portion along the length of the inlet hose 14. Preferably, the chemical tank 50 is located above the waterline 46 to prevent any water damage from leakage, humidity and/or spilled chemicals. The chemical tank 50 includes a volume display 58 that shows the amount of chemical 60 left in the tank 50. The tank 50 has a drain valve 56 that allows a user to open or close the tank 50 to allow the chemical 60 to be distributed throughout the system 2, via the tank outlet 54. When the valve 56 is opened (as shown in FIG. 5), the chemical 60 is forced into the inlet hose 14, by way of gravity and the force of the pump 34. The chemical then distributes into the system 2 with the same pattern as the unstrained fluid 16 and strained fluid 32. When the valve 56 is closed (as shown in FIG. 4), the system 2 operates as if the tank was not connected to the system 2. That is, the system 2 would operate in the same fashion as represented in FIG. 1. The chemical 60 is added to the tank 50 via the tank access port 52.

As shown in FIG. 5, when the valve 56 is opened, the combination of unstrained fluid 16, strained fluid 32 and the chemical 60 forms a chemical mixture 62. The mixture 62 may be a mixture of unstrained fluid 16 and an anti-fouling liquid, such as Barnacle Buster®, as the chemical agent 60. Furthermore, the ratio of unstrained fluid 16, strained fluid 32 and chemical agent 60 composes the chemical mixture 62 and may be of any ratio. That is, inlet hose 14 may have a volume of 99% unstrained fluid 16 and only 1% of chemical agent 60, at the beginning of the system. When the mixture 62 leaves the processing unit 10 via the outlet port 20, the mixture 62 would ideally be composed of only strained fluid 32 and chemical 60.

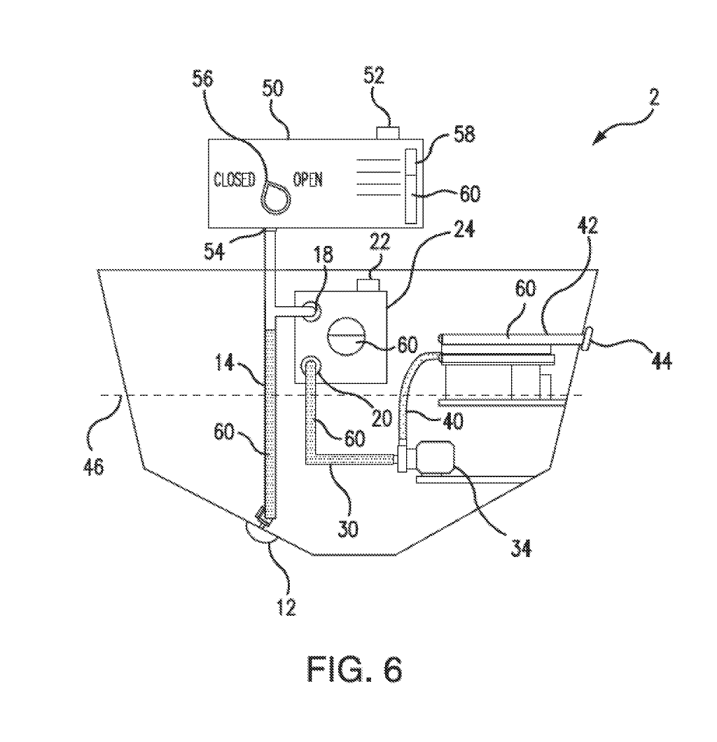

As shown in FIG. 6, the valve 56 is switched to an off position, after the valve 56 has been open for a considerable period of time. The pump 34 has also been turned off for a longer period of time than the valve 56 has been opened, before switching to an off position. The chemical agent 60 is then free to fill the system 2, ridding the system 2 of any unstrained 16 or strained fluid 32. The chemical agent 60 is then allowed to reach equilibrium, in view of the system's 2 components.

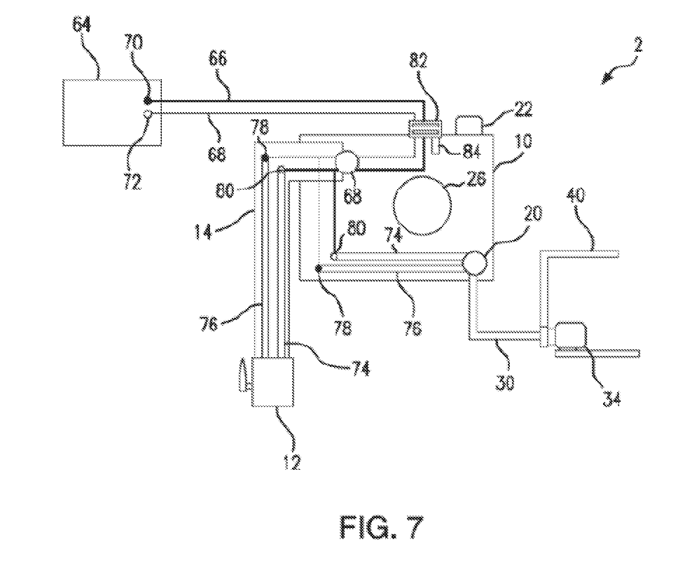

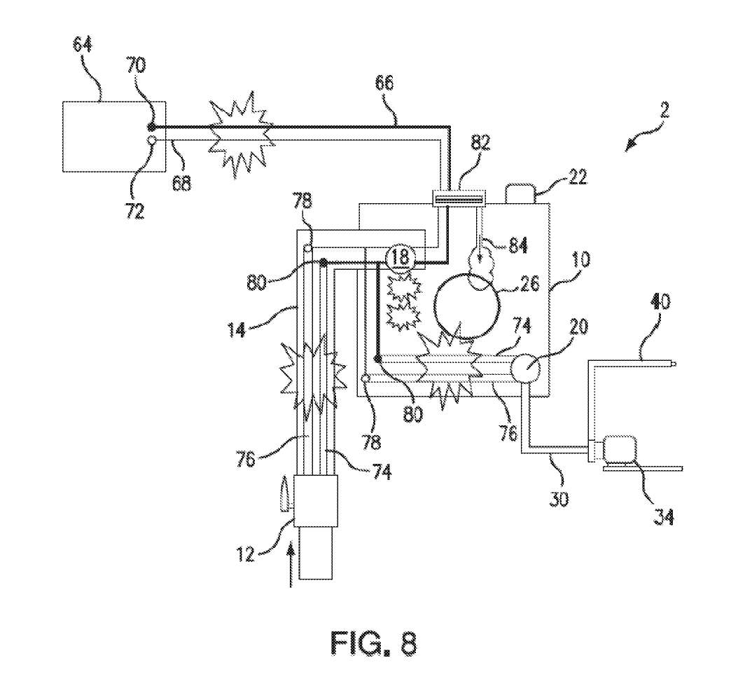

As shown in FIGS. 7 and 8, the system 2 may include an anti-fouling electrode assembly. This includes a DC power supply 64 that provides the energy for the anti-fouling system. Also included are negative 66 and positive 68 wires that connect to the power supply's 64 negative terminal 70 and positive terminal 72, respectively. The negative 66 and positive 68 wires are further connected to the vacuum switch 82. The vacuum switch 82 allows a pressure gradient to be monitored within the processing unit 10 via the vacuum port 84. When a gradient is formed within the processing unit 10, the pressure valve 82 activates, which then activates the corresponding electrodes within the system 2. The vacuum switch 82 is further connected to multiple conductive wire electrodes 74 and 76. Specifically, the vacuum switch 82 has a negative wire 66 connected to a negative wire electrode 74, via a negative terminal electrode 80, located within the inlet hose 14 and a positive wire 68 connected to a positive wire electrode 76, via a positive terminal electrode 80, located within the inlet hose 14. Both conductive wire electrodes 76 and 74 may be the entire length of the inlet hose 14 or a length less than the length of the inlet hose 14. The two wire electrodes 76 and 74 are further included within the processing unit 10 and connected to positive and negative electrode terminals 78 and 80, respectively, located within the processing unit 10. The two wire electrodes 76 and 74 may run the length of the processing unit 10 or may be a length less than the length of the processing unit 10. Furthermore, the two wire electrodes 76 and 74 may create a spiral pattern within the processing unit 10 or may compose the entire surface area of the processing unit 10. Notably, the two wire electrodes 76 and 74 would not encompass the entire volume of the processing unit 10.

As shown in FIG. 8, when the pump 34 is operational, a vacuum condition is created within the processing unit 10. The vacuum is sensed by the vacuum port 84, thus allowing the vacuum switch 82 to activate the wire electrodes 74 and 76. The activated wire electrodes 74 and 76 then create an anti-fouling environment within the inlet hose 14 and processing unit 10 to eliminate, either partially or completely, organic growth of organic matter.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. An aeration and organic growth suppression system for a vessel, comprising in combination:
a heat exchanger mounted within the vessel, said heat exchanger including an inlet;
a pump configured to flow water through an inlet hose from an exterior portion of the vessel to said inlet of said heat exchanger; and
a processing unit positioned within the vessel about a waterline of the vessel, said processing unit comprising a housing, strainer, inlet port fluidly connected to said strainer, and an outlet port fluidly connected to said housing, said outlet port being positioned below said strainer, said inlet port and said outlet port being fluidly connected inline with said inlet hose upstream of said pump.

2. The system of claim 1 wherein the processing unit further includes an access port to the housing.

3. The system of claim 1 wherein the processing unit is fluidly connected to a chemical tank.

4. The system of claim 1 wherein the processing unit further includes an anti-fouling electrode assembly.

5. The system of claim 1 wherein the inlet hose further includes an anti-fouling electrode assembly.

6. The system of claim 1 wherein the strainer is composed of stainless steel.

7. The system of claim 1 wherein the strainer is composed of polyvinyl chloride.

8. An aeration and organic growth suppression processing unit for a vessel comprising:
a processing unit to be positioned within the vessel about a waterline of the vessel, said processing unit comprising a housing, strainer, inlet port fluidly connected to said strainer, and an outlet port fluidly connected to said housing, said outlet port being positioned below said strainer.

9. The unit of claim 8 wherein the processing unit further includes an access port to the housing.

10. The unit of claim 8 wherein the processing unit is fluidly connected to a chemical tank.

11. The unit of claim 8 wherein the processing unit further includes an anti-fouling electrode assembly.

12. The unit of claim 8 wherein the strainer is composed of stainless steel.

13. The unit of claim 8 wherein the strainer is composed of polyvinyl chloride.

14. A method of cooling a raw water heat exchanger in a vessel comprising the steps of:
pumping water through an inlet hose from an exterior portion of the vessel to the inlet of the heat exchanger; and
operating a processing unit positioned within the vessel above a waterline of the vessel to flow water into the inlet of the heat exchanger, the processing unit comprising a housing, strainer, inlet port fluidly connected to the strainer, and an outlet port fluidly connected to the housing, the outlet port being positioned below the strainer, the inlet port and the outlet port being fluidly connected inline with the inlet hose upstream of the pump.

15. The method of claim 14 wherein the processing unit further includes an access port to the housing.

16. The method of claim 14 wherein the processing unit is fluidly connected to a chemical tank.

17. The method of claim 14 wherein the processing unit further includes an anti-fouling electrode assembly.

18. The method of claim 14 wherein the inlet hose further includes an anti-fouling electrode assembly.

19. The method of claim 14 wherein the strainer is composed of stainless steel.

20. The method of claim 14 wherein the strainer is composed of polyvinyl chloride.
